(19) United States
(12) Patent Application Publication
(10) Pub. No.: US 2009/0313683 A1
(43) Pub. Date: Dec. 17, 2009

(54) IMAGE PROCESSING APPARATUS, DATA PROCESSING APPARATUS, AUTHENTICATION METHOD, DEFINITION DATA UPDATING METHOD, AND AUTHENTICATION PROGRAM AND DEFINITION DATA UPDATING PROGRAM EACH EMBODIED ON COMPUTER READABLE MEDIUM

(75) Inventor: Akira MURAKAWA, Osaka (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/404,744

(22) Filed: Mar. 16, 2009

(30) Foreign Application Priority Data
Jun. 16, 2008 (JP) 2008-156397

(51) Int. Cl. H04L 9/32; G06F 21/00

(52) U.S. Cl. 726/5; 726/17

(57) ABSTRACT

In order to facilitate maintenance of definition data in which permission or non-permission to execute a process is defined for a respective user, an MFP includes a process execution portion capable of executing processes, a user authentication portion, a definition data acquiring portion to acquire, for the authenticated user, user definition data defining a defined process for which permission or non-permission to execute the process is predetermined and also defining permission or non-permission to execute an undefined process other than the defined process, and a determination portion to determine, for each of the processes the process execution portion can execute, that the user is permitted to execute the process if it is set as the defined process and execution thereof is permitted in the user definition data, or if it is not set as the defined process but execution of the undefined process is permitted therein.

This application is based on Japanese Patent Application No. 2008-156397 filed with Japan Patent Office on Jun. 16, 2008, the entire content of which is hereby incorporated by reference.

### BACKGROUND OF THE INVENTION

1. Field of the Invention

The present invention relates to an image processing apparatus, a data processing apparatus, an authentication method, a definition data updating method, and an authentication program and a definition data updating program each embodied on a computer readable medium. More particularly, the present invention relates to an image processing apparatus which restricts, for a respective user, the processes that the user is permitted to execute, an authentication method and an authentication program, embodied on a computer readable medium, which are carried out in the image processing apparatus, a data processing apparatus which can communicate with the image processing apparatus, and a definition data updating method and a definition data updating program, embodied on a computer readable medium, which are carried out in the data processing apparatus.

2. Description of the Related Art

In recent years, an image processing apparatus, represented by a multi-function peripheral (MFP), carries out a plurality of processes including copying, transmission/reception of facsimile data, and storage of data, as a central processing unit (CPU) for controlling the apparatus executes programs.

The MFP, used by a plurality of users, has the function of restricting, for a respective user, the processes that the user is permitted to cause the MFP to execute. To this end, the MFP stores user definition data which defines, for a respective user, the processes that the user is permitted to cause the MFP to execute, and the MFP carries out only the processes that are allowed to the authenticated user by the user definition data. A user restraint system storing such user definition data in a server is described in Japanese Patent Application Laid-Open No. 2004-289302.

Specifically, Japanese Patent Application Laid-Open No. 2004-289302 discloses a user restraint system adapted to an image processing apparatus connected to a network, wherein when a user logs in a server in the network and accesses a user database stored in the server, the use of the functions of the image processing apparatus is limited according to the access right.

However, the user definition data needs to be overwritten in the case where a program which enables execution of a new process is installed in the MFP, or in the case where an MFP which can execute a new process is installed.

### SUMMARY OF THE INVENTION

The present invention has been accomplished in view of the foregoing problems, and an object of the present invention is to provide an image processing apparatus which facilitates maintenance of definition data in which permission or non-permission to execute a process is defined for a respective user.

Another object of the present invention is to provide a data processing apparatus which facilitates maintenance of the definition data in which permission or non-permission to execute a process is defined for a respective user.

A further object of the present invention is to provide an authentication method and an authentication program which facilitate maintenance of the definition data in which permission or non-permission to execute a process is defined for a respective user.

Yet another object of the present invention is to provide a definition data updating method and a definition data updating program which facilitate maintenance of the definition data in which permission or non-permission to execute a process is defined for a respective user.

In order to achieve the above objects, according to an aspect of the present invention, an image processing apparatus includes: a process execution portion capable of executing a plurality of processes; a user authentication portion to perform authentication of a user; a definition data acquiring portion to acquire user definition data for the user authenticated by the user authentication portion, the user definition data defining a defined process for which permission or non-permission to execute the process is predetermined and also defining permission or non-permission to execute an undefined process other than the defined process; and a determination portion to determine, for each of the plurality of processes that the process execution portion is capable of executing, that the user is permitted to execute the process in the case where the process is set as the defined process and execution of the process is permitted in the user definition data or in the case where the process is not set as the defined process but execution of the undefined process is permitted in the user definition data.

According to another aspect of the present invention, a data processing apparatus includes: a communication portion capable of communicating with first and second image processing apparatuses; a definition data acquiring portion to acquire user definition data from the first image processing apparatus, the user definition data defining, for a respective user, a defined process for which permission or non-permission to execute the process is predetermined and permission or non-permission to execute an undefined process other than the defined process; a process information acquiring portion to acquire, from the second image processing apparatus, process information regarding a plurality of processes that the second image processing apparatus is capable of executing; an updating portion to update the acquired user definition data by determining whether the respective user is permitted to execute a process that is among the plurality of processes included in the acquired process information and that is not set as the defined process in the acquired user definition data; and a transmitting portion to transmit the updated user definition data to the second image processing apparatus.

According to a further aspect of the present invention, an image processing apparatus includes: a definition data acquiring portion to acquire user definition data which defines, for a respective user, a defined process for which permission or non-permission to execute the process is predetermined and permission or non-permission to execute an undefined process other than the defined process; a process execution portion capable of executing a plurality of processes; and an updating portion to update the acquired user definition data when a process that the process execution portion is capable of executing is added, by determining whether the respective user is permitted to execute the added process based on the permission or non-permission to execute the undefined process defined in the user definition data.

According to a still further aspect of the present invention, an authentication method, which is carried out by an image processing apparatus including a process execution portion capable of executing a plurality of processes, includes the steps of: authenticating a user; acquiring user definition data for the authenticated user, the user definition data defining a defined process for which permission or non-permission to execute the process is predetermined and also defining permission or non-permission to execute an undefined process other than the defined process; and for each of the plurality of processes that the process execution portion is capable of executing, determining that the user is permitted to execute the process in the case where the process is set as the defined process and execution of the process is permitted in the user definition data or in the case where the process is not set as the defined process but execution of the undefined process is permitted in the user definition data.

According to yet another aspect of the present invention, a definition data updating method includes the steps of: acquiring user definition data from a first image processing apparatus, the user definition data defining, for a respective user, a defined process for which permission or non-permission to execute the process is predetermined and permission or non-permission to execute an undefined process other than the defined process; acquiring, from a second image processing apparatus, process information regarding a plurality of processes that the second image processing apparatus is capable of executing; updating the acquired user definition data by determining whether the respective user is permitted to execute a process that is among the plurality of processes included in the acquired process information and that is not set as the defined process in the acquired user definition data; and transmitting the updated user definition data to the second image processing apparatus.

According to yet another aspect of the present invention, an authentication program embodied on a computer readable medium is executed by a computer that controls an image processing apparatus including a process execution portion capable of executing a plurality of processes, and the program causes the computer to perform the steps of: authenticating a user; acquiring user definition data for the authenticated user, the user definition data defining a defined process for which permission or non-permission to execute the process is predetermined and also defining permission or non-permission to execute an undefined process other than the defined process; and for each of the plurality of processes that the process execution portion is capable of executing, determining that the user is permitted to execute the process in the case where the process is set as the defined process and execution of the process is permitted in the user definition data or in the case where the process is not set as the defined process but execution of the undefined process is permitted in the user definition data.

According to yet another aspect of the present invention, a definition data updating program embodied on a computer readable medium causes a computer to perform the steps of: acquiring user definition data from a first image processing apparatus, the user definition data defining, for a respective user, a defined process for which permission or non-permission to execute the process is predetermined and permission or non-permission to execute an undefined process other than the defined process; acquiring, from a second image processing apparatus, process information regarding a plurality of processes that the second image processing apparatus is capable of executing; updating the acquired user definition data by determining whether the respective user is permitted to execute a process that is among the plurality of processes included in the acquired process information and that is not set as the defined process in the acquired user definition data; and transmitting the updated user definition data to the second image processing apparatus.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram of an image processing system according to an embodiment of the present invention.

FIG. 2 is a perspective view of an MFP.

FIG. 3 is a block diagram showing an example of the hardware configuration of the MFP.

FIG. 4 is a block diagram showing an example of the hardware configuration of a server.

FIG. 5 is a functional block diagram showing an example of the functions of a CPU included in the MFP, together with information stored in an HDD.

FIG. 6 is a diagram showing an example of the format of user data.

FIG. 7 is a first diagram showing an example of the format of user definition data.

FIG. 8 is a flowchart illustrating an example of the flow of authentication processing.

FIG. 9 is a flowchart illustrating an example of the flow of user definition data transmission processing.

FIGS. 10A and 10B show user definition data of users A and B, respectively.

FIGS. 11A and 11B show processes that can be executed by the MFP as well as apparatus-based information, before and after modification of the functions, respectively.

FIGS. 12A and 12B show whether users A and B, respectively, are permitted to execute a respective one of the processes that the MFP has become capable of executing after modification of the functions.

FIG. 13 is a second diagram showing an example of the format of the user definition data.

FIGS. 14A and 14B show user definition data of users A and B, respectively, according to a modification.

FIGS. 15A and 15B show whether users A and B, respectively, are permitted to execute a respective one of the processes that the MFP has become capable of executing after modification of the functions.

FIG. 16 is a functional block diagram showing an example of the functions of the CPU in the MFP according to a second embodiment, together with the information stored in the HDD.

FIG. 17 is a first flowchart illustrating an example of the flow of user definition data updating processing.

FIG. 18 is a flowchart illustrating an example of the flow of log-in processing.

FIGS. 19A and 19B show updated user definition data of users A and B, respectively.

FIGS. 20A and 20B show updated user definition data of users A and B, respectively, according to a modification.

FIG. 21 is a functional block diagram schematically showing the functions of the CPU included in the server according to a third embodiment.

FIG. 22 is a second flowchart illustrating an example of the flow of the user definition data updating processing.

### DESCRIPTION OF THE PREFERRED EMBODIMENTS

Embodiments of the present invention will now be described with reference to the drawings. In the following description, like reference characters denote like parts, which have like names and functions, and therefore, detailed description thereof will not be repeated.

### First Embodiment

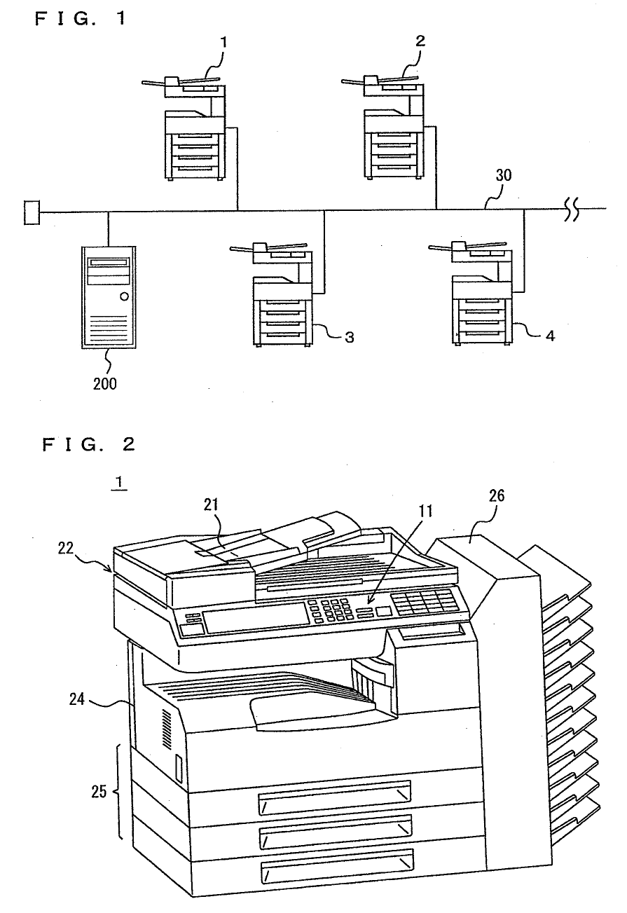

FIG. 1 schematically shows an image processing system according to an embodiment of the present invention. Referring to FIG. 1, the image processing system includes multi-function peripherals (hereinafter, “MFPs”) 1 to 4 serving as image processing apparatuses, and a server 200 serving as a data processing apparatus, which are connected to a network 30. While the illustrated example has four MFPs 1 to 4 connected to network 30, the number of the MFPs is not restricted thereto; it may be any number at least one. Further, the image processing apparatus may be any apparatus provided with the function of forming images, besides MFPs 1 to 4, which may be a facsimile machine, a printer, and the like. Network 30 is a local area network (LAN), which may be wired or wireless. Network 30 is not restricted to the LAN; it may be a wide area network (WAN), public switched telephone networks (PSTN), the Internet, and the like.

MFPs 1 to 4 may or may not be identical in functions. Basically, they each have at least one of the following functions: an image reading function of reading an original to output image data; an image processing function of processing the image data; an image forming function of forming an image on a sheet of paper and the like based on the image data; a post-processing function of performing punching, sorting, and other processing on the sheets of paper with the images formed thereon; and a facsimile transmitting/receiving function. Although MFPs 1 to 4 may not be identical in functions, it is here assumed that MFP 1 and at least one of the other MFPs 2 to 4 have a common function.

FIG. 2 is a perspective view of the MFP. Referring to FIG. 2, MFP 1 includes an automatic document feeder (ADF) 21, an image reading portion 22, an image forming portion 24, a paper feeding portion 25, and a post-processing portion 26. Further, MFP 1 includes an operation panel 11 on its upper surface, which is used as a user interface.

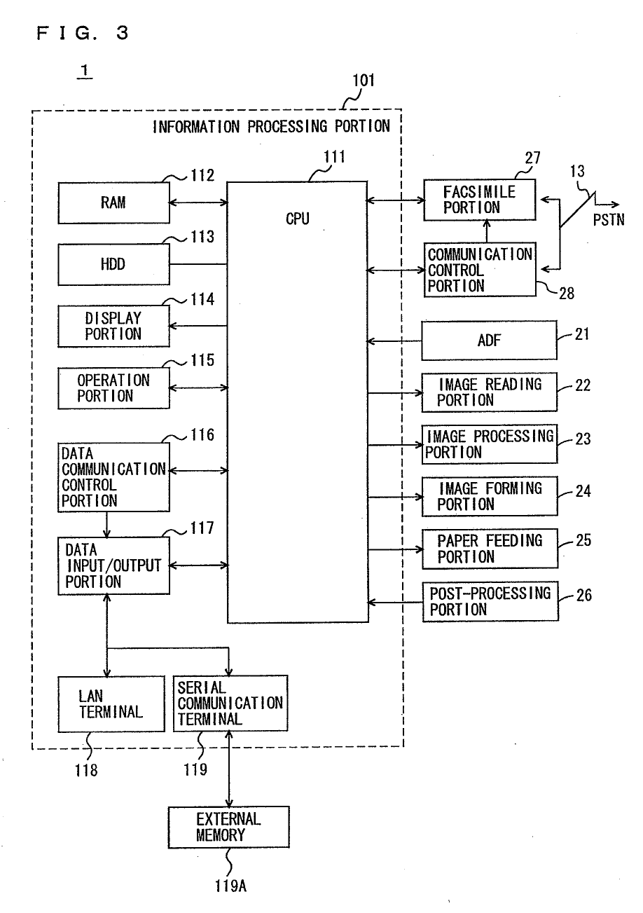

FIG. 3 is a block diagram showing an example of the hardware configuration of the MFP. Referring to FIG. 3, MFP 1 includes an information processing portion 101, a facsimile portion 27, a communication control portion 28, and an image processing portion 23, in addition to ADF 21, image reading portion 22, image forming portion 24, paper feeding portion 25, and post-processing portion 26 shown in FIG. 2. Information processing portion 101 includes a central processing unit (CPU) 111, a random access memory (RAM) 112 used as a work area of CPU 111, a hard disk drive (HDD) 113 for storing data in a non-volatile manner, a display portion 114, an operation portion 115, a data communication control portion 116, and a data input/output portion 117. CPU 111 is connected to data input/output portion 117, data communication control portion 116, operation portion 115, display portion 114, HDD 113, and RAM 112, and is responsible for overall control of information processing portion 101. Further, CPU 111 is connected to facsimile portion 27, communication control portion 28, ADF 21, image reading portion 22, image processing portion 23, image forming portion 24, paper feeding portion 25, and post-processing portion 26, and is responsible for overall control of MFP 1.

ADF 21 delivers a plurality of originals mounted on an original platform one by one to image reading portion 22. In order to cause image reading portion 22 to read both sides of the originals, ADF 21 delivers each original to image reading portion 22 to cause it to read the front side, and then turns over the original and delivers it to image reading portion 22 again to cause it to read the back side. Image reading portion 22 reads image information such as photographs, letters, and pictures from the originals in an optical manner, to obtain image data. In receipt of the image data, image forming portion 24 prints images on sheets of paper and the like based on the image data. Paper feeding portion 25 has a plurality of paper feed trays, and supplies the sheets of paper stored in the designated tray one by one to image forming portion 24.

Post-processing portion 26 discharges the sheets of paper having the images formed thereon. Post-processing portion 26 has a plurality of discharge trays, and is provided with a sorting portion, a punching portion, and a stapling portion. The sorting portion sorts the sheets of paper having the images formed thereon to discharge them to a plurality of discharge trays. The punching portion punches holes in the sheets of paper. The stapling portion staples together the sheets of paper having the images formed thereon.

Image processing portion 23, controlled by CPU 111, performs image processing on the image data based on an instruction from CPU 111. The image data may include: the image data that image reading portion 22 outputs by reading an original; the image data that is received by data input/output portion 117 from server 200 or one of the other MFPs 2 to 4; and the image data stored in HDD 113. The image processing may include: scaling an image; combining a plurality of images to generate an image; and rotating an image to change the direction.

Display portion 114 is a display such as a liquid crystal display (LCD), an organic electro-luminescence display (ELD) or the like, and displays an instruction menu for the user, information about acquired image data, and others. Operation portion 115 is provided with a plurality of keys, and accepts input of data such as instructions, characters, and numerical characters, according to the key operations of the user. Operation portion 115 further includes a touch panel provided on display portion 114. Display portion 114 and operation portion 115 substantially constitute operation panel 11.

Data communication control portion 116 is connected with data input/output portion 117. Data communication control portion 116 controls data input/output portion 117 in accordance with an instruction from CPU 111, to transmit and receive data to and from an external apparatus connected to data input/output portion 117. Data input/output portion 117 includes a LAN terminal 118, which is an interface for communication according to a communication protocol such as transmission control protocol (TCP) or file transfer protocol (FTP), and also includes a serial communication terminal 119.

In the case where LAN terminal 118 is connected to a LAN cable for connection with network 30, data communication control portion 116 controls data input/output portion 117 to communicate with server 200 or the other MFPs 2 to 4 connected thereto, via LAN terminal 118.

In the case where serial communication terminal 119 is connected to an apparatus, data communication control portion 116 controls data input/output portion 117 to communicate with the connected apparatus for input/output of data. Serial communication terminal 119 may be connected with an external memory 119A having a flash memory therein. External memory 119A stores an authentication program, which will be described later. CPU 111 controls data communication control portion 116 to read the authentication program from external memory 119A, and stores the read program in RAM 112 for execution.

The recording medium for storing the authentication program is not restricted to external memory 119A. It may be a flexible disk, a cassette tape, an optical disc (compact disc-read only memory (CD-ROM), magneto-optical (MO) disc, mini disc (MD), digital versatile disc (DVD)), an IC card, an optical card, or a semiconductor memory such as a mask ROM, an erasable programmable ROM (EPROM), an electrically EPROM (EEPROM), or the like. Alternatively, CPU 111 may download the authentication program from server 200 connected to network 30 and store the same in HDD 113, or server 200 may write the authentication program to HDD 113, and thereafter, the authentication program stored in HDD 113 may be loaded to RAM 112 for execution by CPU 111. As used herein, the “program” includes, not only the program directly executable by CPU 111, but also a source program, a compressed program, an encrypted program, and others.

Facsimile portion 27 is connected to the PSTN 13, and transmits facsimile data to or receives facsimile data from PSTN 13. Facsimile portion 27 stores the received facsimile data in HDD 113. It also converts the facsimile data to print data that can be printed by image forming portion 24, and outputs it to image forming portion 24. In response, image forming portion 24 prints the facsimile data received by facsimile portion 27 onto a sheet of paper. Further, facsimile portion 27 converts the data stored in HDD 113 to facsimile data, and outputs it to a facsimile machine connected to PSTN 13.

HDD 113 stores process information in which processes that can be executed by MFP 1 are defined. The process information stored in HDD 113 by MFP 1 includes the information about the following processes: a facsimile process of transmitting/receiving facsimile data; a printing process of forming an image from print data; a scanning process of reading an original to store image data; an external memory storage process of storing data in an external memory; a manual destination input process of inputting a destination of data; and a toner saving process performed by image forming portion 24 to form an image with a reduced amount of toner. It may also include the information about the following processes: a double-side reading process of reading both sides of an original; a color printing process of forming an image in color; a double-side printing process of forming images on both sides; a scaling process of changing an image size; an N-in-1 process of combining images of a plurality of pages; a sorting process; a stapling process; and a punching process.

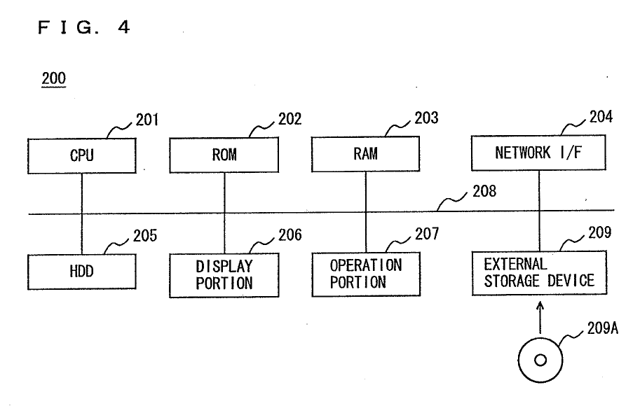

FIG. 4 is a block diagram showing an example of the hardware configuration of the server. Referring to FIG. 4, server 200 includes: a CPU 201 for overall control of server 200; a ROM 202 for storing a program executed by CPU 201 and the like; a RAM 203 used as a work area for CPU 201; a network I/F 204 for connecting server 200 to network 30; an HDD 205 as a mass storage; a display portion 206; an operation portion 207 to accept an input of user operation; and an external storage device 209, which are each connected to a bus 208.

External storage device 209 is mounted with a CD-ROM 209A which stores a definition data updating program. CPU 201 loads the definition data updating program stored in CD-ROM 209A via external storage device 209 to RAM 203 for execution. It is noted that the recording medium for storing the definition data updating program is not restricted to CD-ROM 209A. It may be a flexible disk, a cassette tape, an optical disc (MO, MD, DVD), an IC card, an optical card, or a semiconductor memory such as a mask ROM, an EPROM, an EEPROM, or the like. Alternatively, the definition data updating program stored in HDD 205 may be loaded to RAM 203 for execution. In this case, server 200 may download the definition data updating program from another computer connected to network 30 and store the program in HDD 205. As used herein, the “program” includes, not only the program directly executable by CPU 201, but also a source program, a compressed program, an encrypted program, and others.

FIG. 5 is a functional block diagram showing an example of the functions of the CPU included in the MFP, together with information stored in the HDD. Referring to FIG. 5, CPU 111 included in MFP 1 includes: an authentication portion 51 to perform authentication of a user; a definition data acquiring portion 53 to acquire user definition data; a determination portion 55 for determining a process that an authenticated user is permitted to execute; an operation accepting portion 59 to accept an operation; a process execution portion 57 which is capable of executing a plurality of processes; and an apparatus-based setting portion 61 to set apparatus-based information.

Authentication portion 51 performs authentication of the user who operates MFP 1. Specifically, when the user inputs authentication information to operation portion 115, it accepts the authentication information from operation portion 115, and transmits the accepted authentication information to server 200 via data communication control portion 116 to request server 200 to perform the authentication. Here, the authentication information includes a user ID and a password. The user ID is user identification information for identification of a user, which is predetermined for a respective user. In receipt of the authentication information, server 200 compares the authentication information with prestored user data, and if there is the user data that matches the received authentication information, it returns an authentication result indicating that the authentication has been successful; otherwise, it returns an authentication result indicating that the authentication has failed.

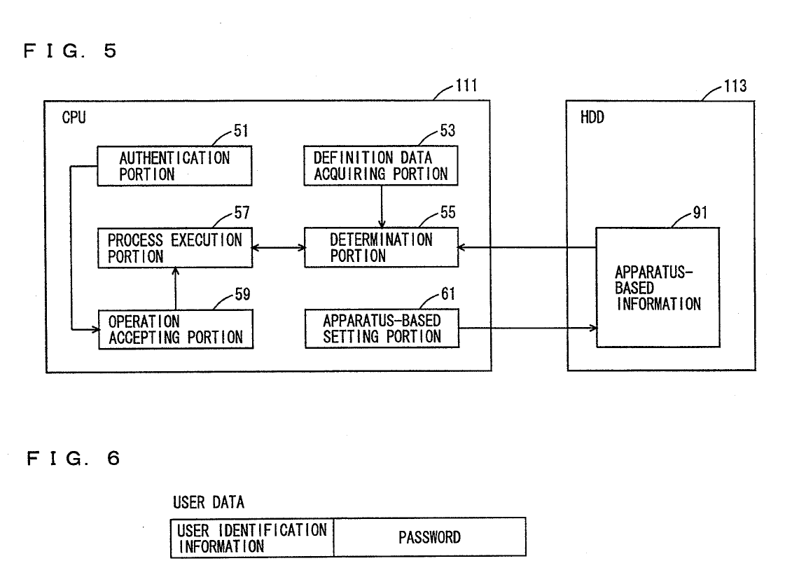

The user data will now be described. FIG. 6 shows an example of the format of the user data. Referring to FIG. 6, the user data includes user identification information for identification of the user, and a password.

Returning to FIG. 5, when data communication control portion 116 receives an authentication result from server 200, authentication portion 51 accepts the authentication result. When the authentication result indicates that the authentication has been successful, authentication portion 51 outputs the authentication result to operation accepting portion 59. If the authentication result indicates that the authentication has failed, authentication portion 51 displays an error message on display portion 114. The authentication information may be biological information of the user, such as a fingerprint, vein pattern, or iris pattern.

Further, when the authentication has been successful, server 200 outputs, together with the authentication result, user definition data including the user identification information of the authenticated user. The user definition data will now be described.

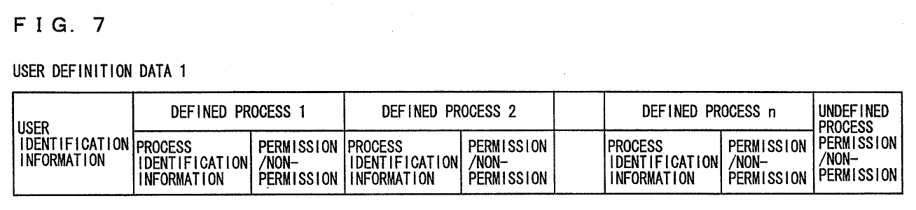

FIG. 7 is a first diagram showing an example of the format of the user definition data. Referring to FIG. 7, the user definition data includes: a “user identification information” field; “defined process 1” to “defined process n” fields; and an “undefined process permission/non-permission” field. Each of the “defined process 1” to “defined process n” fields includes information regarding a defined process for which permission or non-permission to execute the process has been set for the user identified by the user identification information. Specifically, each “defined process” field includes a “process identification information” field in which process identification information for identification of the defined process is set, and a “permission/non-permission” field in which permission or non-permission to execute the defined process is set. Server 200 transmits the user definition data including the user identification information of the authenticated user to MFP 1.

Returning to FIG. 5, when data communication control portion 116 receives the user definition data from server 200, definition data acquiring portion 53 accepts the user definition data. Definition data acquiring portion 53 outputs the accepted user definition data to determination portion 55.

Apparatus-based setting portion 61 sets apparatus-based information. Specifically, it displays an apparatus-based information setting screen on display portion 114, and accepts apparatus-based information that the user inputs to operation portion 115 according to the apparatus-based information setting screen. It then stores the accepted apparatus-based information in HDD 113. As a result, apparatus-based information 91 is stored in HDD 113. The apparatus-based information defines whether MFP 1 permits execution of an undefined process. It is desirable that the user who sets the apparatus-based information is the administrator of MFP 1.

Operation accepting portion 59, when accepting the authentication result from authentication portion 51, accepts an operation that the user inputs to operation portion 115. Operation accepting portion 59 outputs the accepted operation to process execution portion 57. Once authentication portion 51 has succeeded in authentication, the operations accepted by operation accepting portion 59 until the authenticated user logs out are regarded as those input by the authenticated user.

In receipt of an operation from operation accepting portion 59, process execution portion 57 inquires of determination portion 55 whether execution of the process corresponding to the input operation is permitted. Specifically, process execution portion 57 outputs the process identification information for identification of the process corresponding to the operation to determination portion 55. As a result of the inquiry, if an enable signal is input from determination portion 55, process execution portion 57 carries out the process corresponding to the operation input from operation accepting portion 59. If a disable signal is input from determination portion 55, process execution portion 57 displays an error message on display portion 114, without executing the process corresponding to the operation input from operation accepting portion 59.

Determination portion 55 determines a process that the authenticated user is permitted to execute, based on the user definition data. Specifically, it determines whether the process identification information that is input from process execution portion 57 is set in the corresponding field in a “defined process” field and execution thereof is permitted in the user definition data that is input from definition data acquiring portion 53. If the process identification information input from process execution portion 57 is set in the “defined process” field and execution of the process is permitted in the user definition data, determination portion 55 outputs an enable signal to process execution portion 57. On the other hand, if the information is set in the “defined process” field but execution of the process is not permitted, determination portion 55 outputs a disable signal to process execution portion 57.

Further, in the case where the process identification information input from process execution portion 57 is not set in the “defined process” field in the user definition data, determination portion 55 reads apparatus-based information 91 from HDD 113 to determine whether execution of an undefined process is permitted in apparatus-based information 91. If execution of the undefined process is not permitted therein, determination portion 55 outputs a disable signal to process execution portion 57. On the other hand, if execution of the undefined process is permitted in apparatus-based information 91, determination portion 55 outputs an enable signal to process execution portion 57 on the condition that “permitted” is set in the “undefined process permission/non-permission” field in the user definition data, whereas it outputs a disable signal to process execution portion 57 if “not permitted” is set in the “undefined process permission/non-permission” field in the user definition data.

While it has been configured in this example to store apparatus-based information 91 in HDD 113, it may be configured not to store apparatus-based information 91 in HDD 113. In such a case, apparatus-based setting portion 61 becomes unnecessary, and in the case where the process identification information input from process execution portion 57 is not set in the “defined process” field in the user definition data, determination portion 55 outputs an enable signal to process execution portion 57 if “permitted” is set in the “undefined process permission/non-permission” field in the user definition data, while it outputs a disable signal to process execution portion 57 if “not permitted” is set in that field.

Further, it has been configured in this example such that after an operation is accepted in operation accepting portion 59, determination portion 55 determines whether execution of the process corresponding to the operation is permitted. Alternatively, it may be configured such that after a user is authenticated by authentication portion 51, determination portion 55 determines a process that the user is permitted to execute and a process that the user is not permitted to execute. In this case, determination portion 55 may determine for all the processes that can be executed by process execution portion 57 whether the user is permitted to execute them, and set an execute permission flag ON for each of the processes that the user is permitted to execute and set the flag OFF for each of the processes that the user is not permitted to execute, so that process execution portion 57 or operation accepting portion 59 may determine whether execution of a respective process is permitted or not by referring to the execute permission flag. Further, operation accepting portion 59 may be configured not to accept an operation corresponding to the process that the user is not permitted to execute. For example, it may be configured not to display a screen or a button for inputting an operation corresponding to the process that the user is not permitted to execute.

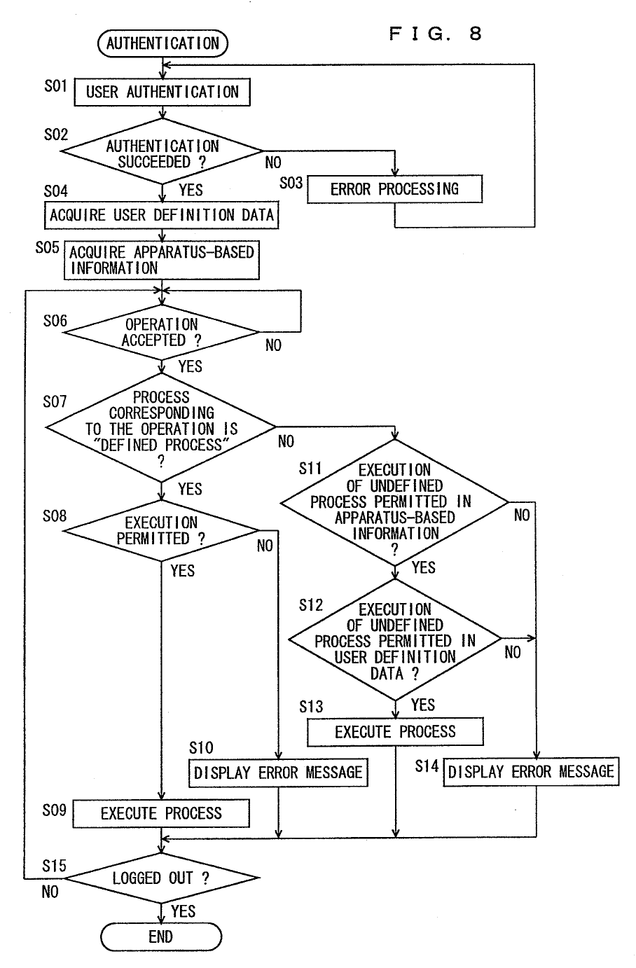

FIG. 8 is a flowchart illustrating an example of the flow of authentication processing. The authentication processing is carried out by CPU 111 included in MFP 1 as CPU 111 executes an authentication program. Referring to FIG. 8, CPU 111 performs user authentication (step S01). Specifically, it accepts user identification information and a password that the user inputs to operation portion 115, and transmits them to server 200 via data communication control portion 116.

In step S02, CPU 111 determines whether the authentication has been successful, based on an authentication result received from server 200. If the authentication result received indicates that the authentication has been successful, the process proceeds to step S04; while if the authentication result received indicates that the authentication has failed, the process proceeds to step S03. In step S03, error processing is carried out, and the process returns to step S01. The error processing is to inform the user that the user is unauthorized. For example, an error message such as “you are not authorized” or “password is wrong” is displayed on display portion 114.

In step S04, user definition data is acquired. Specifically, when data communication control portion 116 receives user definition data from server 200, that user definition data is acquired. The user definition data includes user identification information of the user authenticated in step S01. While server 200 is configured to output the user definition data of the user when the authentication thereof has been successful, alternatively, CPU 111 may be configured to transmit a transmission request for user definition data including the user identification information of the user authenticated in step S01 to server 200, and receive the user definition data that server 200 outputs in response to the request.

In step S05, apparatus-based information is acquired. Specifically, the apparatus-based information stored in HDD 113 is read. While it is here configured to store the apparatus-based information in HDD 113, the apparatus-based information may be stored in another computer, e.g. server 200, and may be received therefrom.

In the following step S06, it is determined whether an operation has been accepted. Specifically, the operation input by the user to operation portion 115 is accepted. CPU 111 is in a standby mode until an operation is accepted (NO in step S06), and once the operation is accepted, the process proceeds to step S07. In step S07, it is determined whether the process corresponding to the accepted operation is a defined process. Specifically, it is determined whether process identification information of the process corresponding to the accepted operation is set in the “defined process” field in the user definition data acquired in step S04. If the information is set in the “defined process” field, the process proceeds to step S08; otherwise, the process proceeds to step S11. In step S08, it is determined whether execution of the process corresponding to the accepted operation is set to be permitted. Specifically, it is determined whether “permitted” is set in the “permission/non-permission” field associated with the process identification information of the process corresponding to the accepted operation, in the user definition data acquired in step S04. If execution of the process corresponding to the accepted operation is set to be permitted, the process proceeds to step S09; otherwise, the process proceeds to step S10.

In step S09, the process corresponding to the operation accepted in step S06 is executed, and the process proceeds to step S15. On the other hand, in step S10, an error message is displayed on display portion 114, and the process proceeds to step S15. The error message can notify the user that the user is not authorized to execute the process corresponding to the input operation.

In step S11, it is determined whether execution of an undefined process is permitted in the apparatus-based information acquired in step S05. If so, the process proceeds to step S12; otherwise, the process proceeds to step S14. In step S14, an error message is displayed, as in step S10, and the process proceeds to step S15.

In step S12, it is determined whether execution of an undefined process is permitted in the user definition data. Specifically, it is determined whether “permitted” is set in the “undefined process permission/non-permission” field in the user definition data acquired in step S04. If “permitted” is set in the “undefined process permission/non-permission” field, the process proceeds to step S13; whereas if “not permitted” is set in that field, the process proceeds to step S14. In step S13, the process is executed, as in step S09, and the process proceeds to step S15.

In step S15, it is determined whether the authenticated user has logged out. If so, the process is terminated; otherwise, the process returns to step S06.

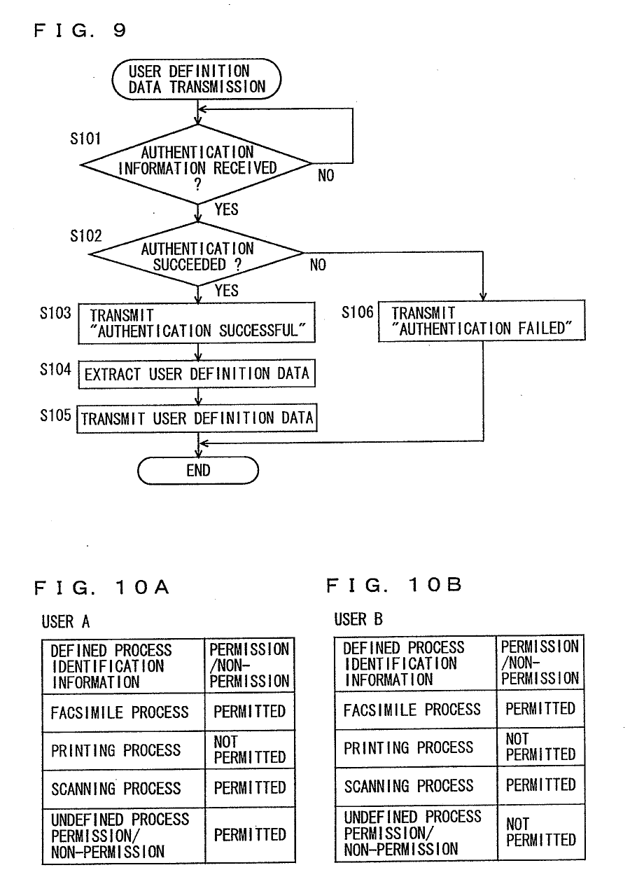

FIG. 9 is a flowchart illustrating an example of the flow of user definition data transmission processing. The user definition data transmission processing is carried out by CPU 201 included in server 200 as CPU 201 executes a user definition data transmission program. Referring to FIG. 9, CPU 201 is in a standby mode until authentication information is received (NO in step S101), and once the authentication information is received (YES in step S101), the process proceeds to step S102. CPU 201 controls network I/F 204 to receive authentication information from one of MFPs 1 to 4, and performs authentication using the received authentication information (step S102). Specifically, it refers to user data prestored in HDD 205 to determine whether there is the user data matching the received authentication information. If there is such user data matching the received authentication information, the process proceeds to step S103; otherwise, the process proceeds to step S106. In step S106, an authentication result indicating that the authentication has failed is returned to the one of MFPs 1 to 4 that issued the authentication information, and the process is terminated.

In step S103, an authentication result indicating that the authentication has been successful is transmitted to the one of MFPs 1 to 4 that issued the authentication information, and the process proceeds to step S104. In step S104, the user definition data including the user identification information of the authenticated user is extracted from the user definition data prestored in HDD 205. The extracted user definition data is transmitted to the one of MFPs 1 to 4 that issued the authentication information (step S105), and the process is terminated.

<Specific Example>

A specific example will now be described. FIGS. 10A and 10B show user definition data of users A and B, respectively. Referring to FIG. 10A, for user A, a facsimile process and a scanning process are permitted, while a printing process is not permitted, as defined processes, and the undefined process permission/non-permission is set as “permitted”. Referring to FIG. 10B, for user B, the facsimile process and the scanning process are permitted, while the printing process is not permitted, as the defined processes, and the undefined process permission/non-permission is set as “not permitted”.

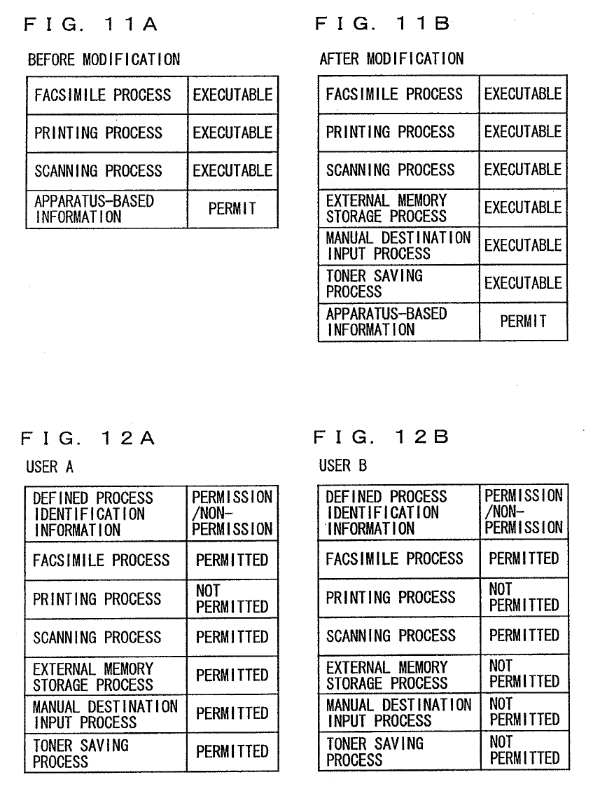

FIGS. 11A and 11B show the processes that the MFP can execute and apparatus-based information, before and after modification of functions, respectively. FIG. 11A shows the processes that can be executed by MFP 1 before modification of the functions and the apparatus-based information. It indicates that MFP 1 is able to execute the facsimile process, the printing process, and the scanning process, and the apparatus-based information is set to “permit” execution of an undefined process. FIG. 11B shows the processes that can be executed by MFP 1 after modification of the functions and the apparatus-based information. It indicates that MFP 1 is able to execute, in addition to the facsimile, printing, and scanning processes, an external memory storage process, a manual destination input process, and a toner saving process, and the apparatus-based information is set to “permit” execution of the undefined process.

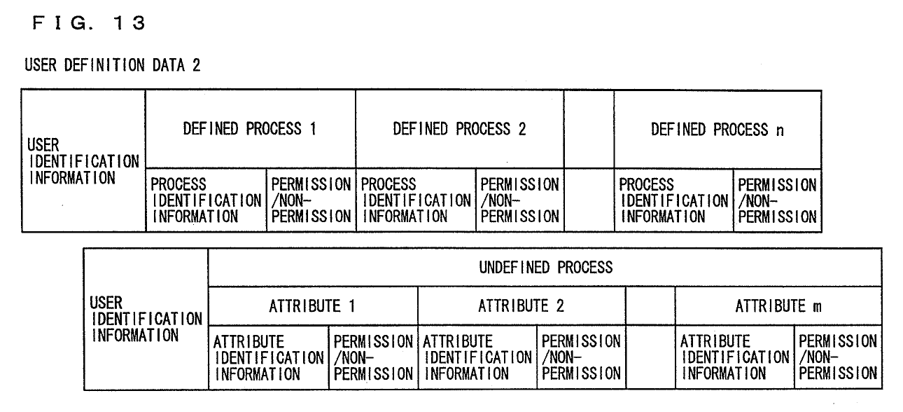

It is here assumed that in the state where the user definition data as shown in FIGS. 10A and 10B are stored in server 200, the functions of MFP 1 are modified, and the processes that MFP 1 can execute change from those shown in FIG. 11A to those shown in FIG. 11B. FIGS. 12A and 12B indicate whether users A and B, respectively, are permitted to execute the respective processes that MFP 1 has become possible to execute after modification of the functions. Referring to FIG. 12A, because “permitted” is set in the “undefined process permission/non-permission” field in the user definition data of user A shown in FIG. 10A, execution is permitted for all the processes that MFP 1 is able to execute after modification of the functions, i.e., the external memory storage process, the manual destination input process, and the toner saving process, in addition to the facsimile and scanning processes. Referring to FIG. 12B, because “not permitted” is set in the “undefined process permission/non-permission” field in the user definition data of user B shown in FIG. 10B, execution is not permitted for any of the external memory storage process, the manual destination input process, and the toner saving process, that MFP 1 has become possible to execute after modification of the functions.

While it is configured in the first embodiment such that the user data and the user definition data are stored in server 200, they may be stored in HDD 113 in MFP 1. In this case, the user authentication processing in step S01 is carried out in CPU 111, and in step S04, the user definition data including the user identification information of the authenticated user is read from HDD 113.

<Modification>

In the first embodiment described above, the user definition data as shown in FIG. 7 is used, in which permission or non-permission to execute a process is defined for a respective process. Alternatively, permission or non-permission to execute a process may be defined according to an attribute which represents processes of a similar type. FIG. 13 is a second diagram showing an example of the format of the user definition data. The user definition data with its format shown in FIG. 13 includes: a “user identification information” field; “defined process 1” to “defined process n” fields; and an “undefined process” field. The “user identification information” field and the “defined process 1” to “defined process n” fields are identical to those in the user definition data shown in FIG. 7. The “undefined process” field includes “attribute 1” to “attribute m” fields, each having an “attribute identification information” field and a “permission/non-permission” field, and permission or non-permission to execute a respective process is set according to the attribute of the process, for the user identified by the user identification information. In the “attribute identification information” field, the attribute identification information for identification of the attribute of the process is set, and in the “permission/non-permission” field, permission or non-permission to execute the process having the attribute specified by the attribute identification information is set.

<Specific Example>

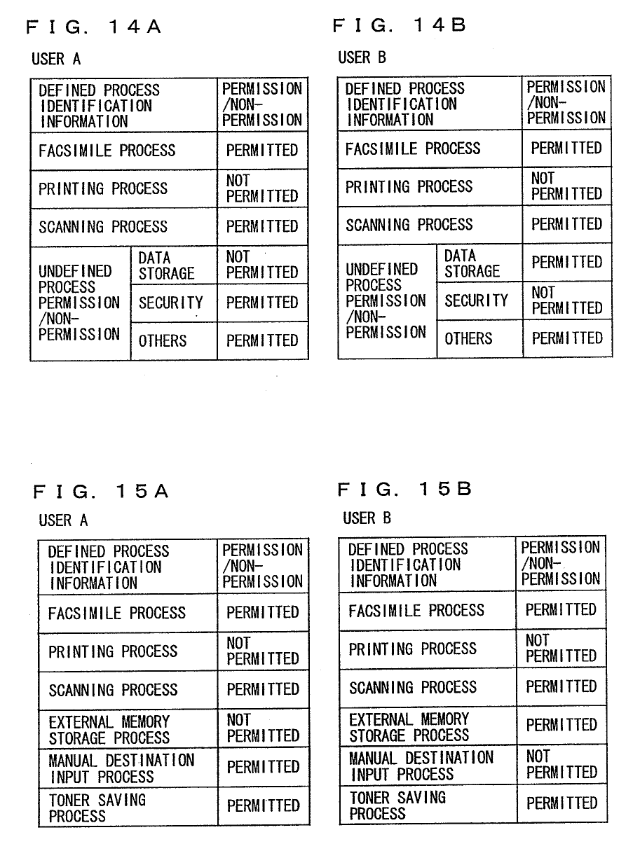

In a specific example of the modification, permission or non-permission to execute an undefined process is defined according to the attribute of the process, in the user definition data. FIGS. 14A and 14B show user definition data of users A and B, respectively, according to the modification. Referring to FIG. 14A, for user A, the facsimile and scanning processes are permitted, while the printing process is not permitted, as the defined processes. As to the permission or non-permission to execute the undefined processes, “not permitted” is set for the process whose attribute is data storage, and “permitted” is set for the process whose attribute is security and for the process whose attribute is others. Referring to FIG. 14B, for user B, the facsimile and scanning processes are permitted, while the printing process is not permitted, as the defined processes. As to the permission or non-permission to execute the undefined processes, “permitted” is set for the process with the attribute of data storage, “not permitted” is set for the process with the attribute of security, and “permitted” is set for the process with the attribute of others.

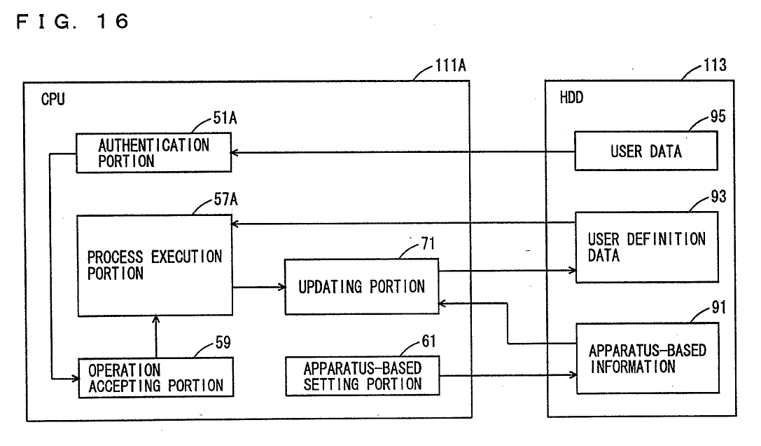

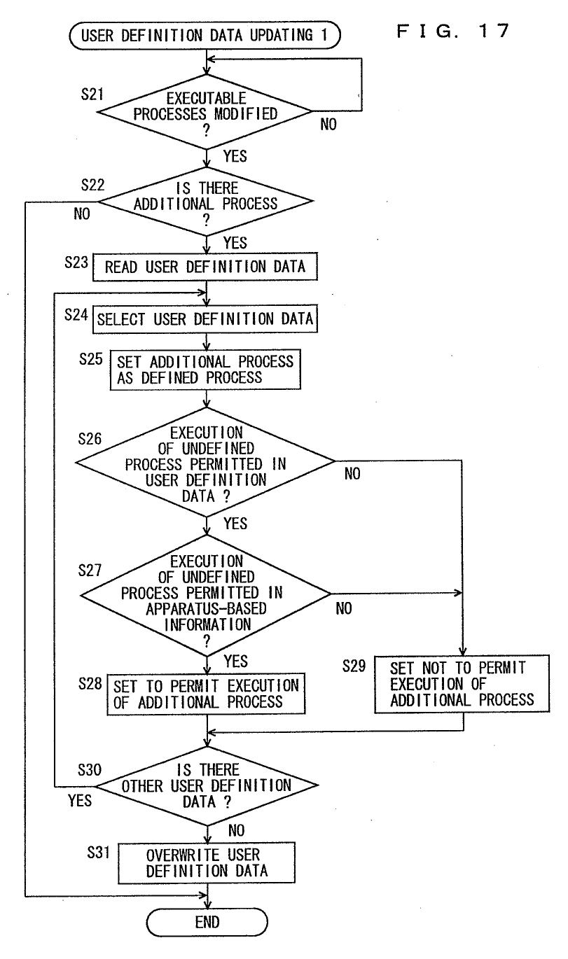

It is here assumed that in the state where the user definition data shown in FIGS. 14A and 14B are stored in server 200, the functions of MFP 1 are modified from the processes shown in FIG. 11A to the processes shown in FIG. 11B. FIGS. 15A and 15B show whether users A and B, respectively, are permitted to execute the respective processes that MFP 1 has become possible to execute as a result of modification of the functions.

Referring to FIG. 15A, in addition to the facsimile and scanning processes that are permitted in the user definition data for user A shown in FIG. 14A, execution of the manual destination input process and the toner saving process that MFP 1 can now execute after modification of the functions is permitted, while execution of the external memory storage process is not permitted. Specifically, because “not permitted” is set for the process with the attribute of data storage in the user definition data shown in FIG. 14A, execution of the process with the attribute of data storage, i.e. external memory storage process, that MFP 1 can now execute after modification of the functions is not permitted. Further, because “permitted” is set for the process with the attribute of security and for the process with the attribute of others in the user definition data shown in FIG. 14A, execution of the manual destination input process, corresponding to the process with the attribute of security, and the toner saving process, corresponding to the process with the attribute of others, that MFP 1 can now execute after modification of the functions is permitted.

Referring to FIG. 15B, in addition to the facsimile and scanning processes that are permitted in the user definition data for user B shown in FIG. 14B, execution of the external memory storage process and the toner saving process, which MFP 1 can now execute after modification of the functions, is permitted, while execution of the manual destination input process is not permitted. Specifically, because “permitted” is set for the process with the attribute of data storage and for the process with the attribute of others in the user definition data shown in FIG. 14B, execution of the external memory storage process having the attribute of data storage and the toner saving process having the attribute of others, which MFP 1 can now execute after modification of the functions, is permitted. Further, because “not permitted” is set for the process with the attribute of security in the user definition data shown in FIG. 14B, execution of the manual destination input process having the attribute of security, which MFP 1 can now execute after modification of the functions, is not permitted.

As described above, according to the image processing system of the first embodiment, each of MFPs 1 to 4 acquires user definition data for an authentication user from server 200, wherein the user definition data defines a defined process for which permission or non-permission to execute the process is predetermined and also defines permission or non-permission to execute an undefined process other than the defined process. In executing a process, each of MFPs 1 to 4 determines that the user is permitted to execute the process if the process is set as the defined process and execution thereof is permitted in the user definition data, or if the process is not set as the defined process but execution of the undefined process is permitted therein. Accordingly, even in the case where any of MFPs 1 to 4 becomes capable of executing a process for which permission or non-permission to execute the same is not defined in the user definition data, it is possible to determine whether the user is permitted to execute that process. This facilitates maintenance of the definition data in which permission or non-permission to execute a respective process is defined for a respective user.

Further, each of MFPs 1 to 4 stores apparatus-based information for setting permission or non-permission to execute an undefined process on an apparatus basis, and determines whether execution of an undefined process is permitted or not, further on the condition that execution of the undefined process is permitted in the apparatus-based information. As such, it is possible to disallow execution of the undefined process on an apparatus basis.

Furthermore, in the modification, permission or non-permission to execute an undefined process is defined according to the attribute of that process in the user definition data. As such, it is possible to set whether to permit execution of an undefined process according to an attribute thereof.

### Second Embodiment

In the image processing system according to the first embodiment described above, the user definition data is stored in server 200. In the image processing system according to a second embodiment, the user definition data is stored and updated in each of MFPs 1 to 4. The hardware configuration of MFP 1 of the second embodiment is identical to that shown in FIG. 3. Hereinafter, MFP 1 according to the second embodiment will be described, focusing primarily on the differences from MFP 1 of the first embodiment.

FIG. 16 is a functional block diagram showing an example of the functions of the CPU 111A included in the MFP 1 according to the second embodiment, together with the information stored in the HDD. The functional block diagram shown in FIG. 16 differs from that shown in FIG. 5 in that the authentication portion 51A and the process execution portion 57A have been modified, definition data acquiring portion 53 has been deleted, and determination portion 55 has been replaced with an updating portion 71. Further, user definition data 93 with its format shown in FIG. 7 and user data 95 with its format shown in FIG. 6 are prestored in HDD 113.

When the user inputs authentication information to operation portion 115, authentication portion 51A accepts the authentication information from operation portion 115, and compares the accepted authentication information with user data 95 stored in HDD 113. If there is the user data matching the accepted authentication information, authentication portion 51A outputs an authentication result indicating that the authentication has been successful to operation accepting portion 59; whereas if such user data does not exist, it outputs an authentication result indicating that the authentication has failed to operation accepting portion 59.

Updating portion 71 determines whether the processes that can be executed by process execution portion 57A have been modified. Specifically, it determines whether the program executed by CPU 111A has been updated by version upgrade, for example. When determining that the processes that can be executed by process execution portion 57A have been modified, updating portion 71 updates user definition data 93. Specifically, among the processes that process execution portion 57A can execute, any process that is not set as a defined process in user definition data 93 is set as a defined process therein. At this time, in the case where execution of an undefined process is permitted in apparatus-based information 91 and “permitted” is set in the “undefined process permission/non-permission” field in user definition data 93, “permitted” is set in the “permission/non-permission” field associated with the process identification information for the process newly set as the defined process. On the other hand, in the case where execution of the undefined process is not permitted in apparatus-based information 91, or in the case where execution of the undefined process is permitted in apparatus-based information 91 but “not permitted” is set in the “undefined process permission/non-permission” field in user definition data 93, then “not permitted” is set in the “permission/non-permission” field associated with the process identification information for the process newly set as the defined process.

When an operation is input from operation accepting portion 59, process execution portion 57A refers to user definition data 93 to determine whether execution of the process corresponding to the input operation is permitted. Specifically, it determines whether the process identification information for identification of the process corresponding to the operation is set in the “defined process” field in user definition data 93 and “permitted” is set in the corresponding “permission/non-permission” field. In the case where the process identification information for identification of the process corresponding to the operation is set in the “defined process” field in the user definition data and “permitted” is set in the “permission/non-permission” field therein, process execution portion 57A executes the process corresponding to the operation input from operation accepting portion 59, whereas in the case where the process is set as the defined process but “not permitted” is set in the “permission/non-permission” field, process execution portion 57A displays an error message on display portion 114.

Further, in the case where the process identification information for identification of the process corresponding to the operation is not set in the “defined process” field in user definition data 93, process execution portion 57A displays an error message on display portion 114.

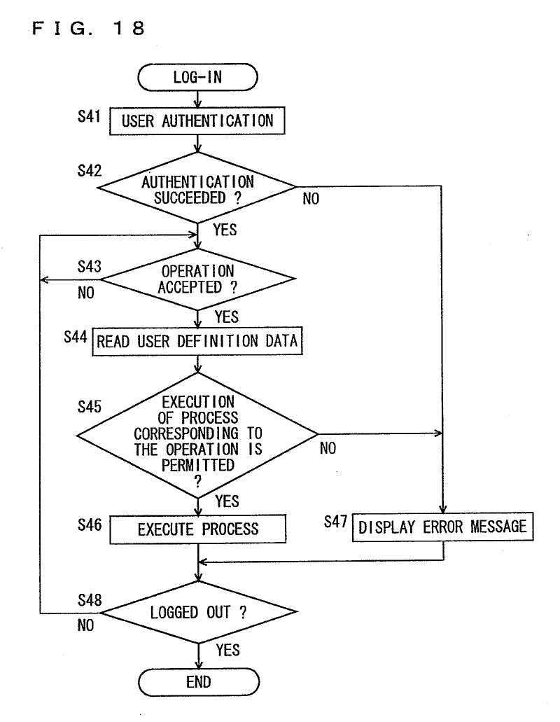

FIG. 17 is a first flowchart illustrating an example of the flow of user definition data updating processing. The user definition data updating processing is carried out by CPU 111A included in MFP 1 of the second embodiment as CPU 111A executes a user definition data updating program. Referring to FIG. 17, CPU 111A determines whether the processes that can be executed by MFP 1 of the second embodiment have been modified. CPU 111A is in a standby mode until the processes executable by MFP 1 are modified (NO in step S21), and once the executable processes are modified (YES in step S21), the process proceeds to step S22. That is, the user definition data updating processing is carried out on the condition that the processes that can be executed by MFP 1 are modified.

In step S22, the processes before and after modification are compared with each other to determine whether there is any process added (hereinafter, referred to as an “additional process”). If there is an additional process, the process proceeds to step S23; otherwise, the process is terminated. This is for the purposes of updating user definition data 93 with respect to the additional process.

In step S23, user definition data 93is read from HDD 113. A first item of user definition data is selected therefrom (step S24). In step S25, the additional process is set as a defined process. Specifically, a “defined process” field is additionally provided in the selected user definition data, and process identification information for identification of the process that is determined to be the additional process is set in the “process identification information” field for the added field.

In step S26, it is determined whether execution of an undefined process is permitted in the selected user definition data. If “permitted” is set in the “undefined process permission/non-permission” field, the process proceeds to step S27; whereas if “not permitted” is set in that field, the process proceeds to step S29. In step S27, it is determined whether execution of an undefined process is permitted in the apparatus-based information. If so, the process proceeds to step S28; otherwise, the process proceeds to step S29. In step S28, execution of the additional process added in step S25 is set to be permitted, and the process proceeds to step S30. Specifically, “permitted” is set in the “permission/non-permission” field for the “defined process” field additionally provided. On the other hand, in step S29, execution of the additional process added in step S25 is set not to be permitted, before the process proceeds to step S30. Specifically, “not permitted” is set in the “permission/non-permission” field for the additionally provided “defined process” field.

In step S30, it is determined whether there is any item of user definition data yet to be selected. If so, the process returns to step S24; otherwise, the process proceeds to step S31. In step S31, user definition data 93 stored in HDD 113 is overwritten, whereby the process is terminated.

FIG. 18 is a flowchart illustrating an example of the flow of log-in processing. The log-in processing is carried out by CPU 111A included in MFP 1 of the second embodiment, as CPU 111A executes a log-in program. Referring to FIG. 18, CPU 111A performs user authentication (step S41). Specifically, user identification information and a password that the user inputs to operation portion 115 are accepted and compared with user data stored in HDD 113. It is then determined whether the authentication has succeeded (step S42). If there is the user data including the user identification information and the password identical to those accepted, it is determined that the authentication has been successful; otherwise, it is determined that the authentication has failed. If the authentication has been successful, the process proceeds to step S43; otherwise, the process proceeds to step S47. In step S47, an error message is displayed on display portion 114.

In step S43, it is determined whether an operation has been accepted. Specifically, it is determined whether the operation the user inputs to operation portion 115 has been accepted. CPU 111A is in a standby mode until an operation is accepted (NO in step S43), and once an operation is accepted (YES in step S43), the process proceeds to step S44. In step S44, user definition data 93 is read from HDD 113. Specifically, user definition data 93 that includes the user identification information of the user authenticated in step S41 is read from HDD 113.

In step S45, it is determined whether execution of the process corresponding to the accepted operation is permitted. Specifically, it is determined, in the user definition data read in step S44, whether the process identification information of the process corresponding to the accepted operation is set in the “defined process” field and “permitted” is set in the “permission/non-permission” field. If execution of the process corresponding to the accepted operation is permitted, the process proceeds to step S46; otherwise, the process proceeds to step S47.

In step S46, the process corresponding to the operation accepted in step S43 is executed, and the process proceeds to step S48. In step S48, it is determined whether the authenticated user has logged out. If so, the process is terminated; otherwise, the process returns to step S43.

<Specific Example>

It is here assumed that in the state where the user definition data as shown in FIGS. 10A and 10B are stored in MFP 1, the functions of MFP 1 are modified, and the processes that can be executed by MFP 1 change from those shown in FIG. 11A to those shown in FIG. 11B. FIGS. 19A and 19B show updated user definition data for users A and B, respectively. Referring to FIG. 19A, compared to the user definition data of user A shown in FIG. 10A where the facsimile, printing, and scanning processes are defined as the defined processes, an external memory storage process, a manual destination input process, and a toner saving process, which are the processes that MFP 1 can now execute after modification of the functions, are newly added as defined processes in the updated user definition data. Further, because “permitted” is set in the “undefined process permission/non-permission” field in the user definition data of user A shown in FIG. 10A, execution is permitted for all the processes newly added as the defined processes, i.e., the external memory storage process, the manual destination input process, and the toner saving process.

Referring to FIG. 19B, compared to the user definition data of user B shown in FIG. 10B where the facsimile, printing, and scanning processes are defined as the defined processes, the external memory storage, manual destination input, and toner saving processes that can newly be executed by MFP 1 after modification of the functions are added as the defined processes in the updated user definition data. Further, because “not permitted” is set in the “undefined process permission/non-permission” field in the user definition data of user B shown in FIG. 10B, execution is not permitted for any of the processes newly added as the defined processes, i.e., the external memory storage, manual destination input, and toner saving processes.

<Modification>

In the second embodiment, as in the modification of the first embodiment described above, the user definition data shown in FIG. 13 may be used instead of the user definition data shown in FIG. 7. Hereinafter, a specific example of using the user definition data shown in FIG. 13 will be described.

<Specific Example>

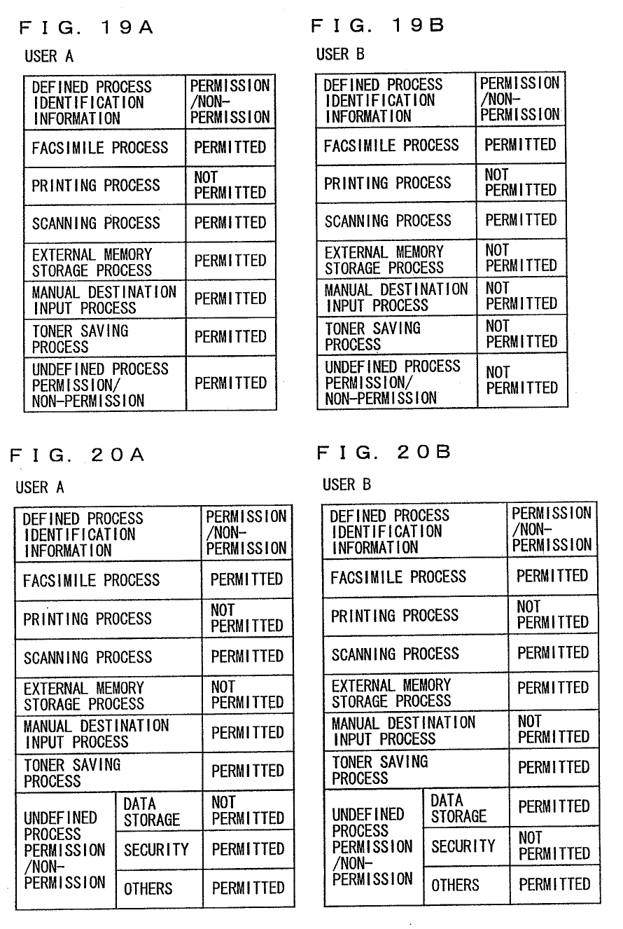

It is here assumed that in the state where the user definition data as shown in FIGS. 14A and 14B are stored in MFP 1, the functions of MFP 1 are modified from the processes shown in FIG. 11A to the processes shown in FIG. 11B. FIGS. 20A and 20B show updated user definition data for users A and B, respectively, in the modification.

Referring to FIG. 20A, compared to the user definition data of user A shown in FIG. 14A where the facsimile, printing, and scanning processes are defined as the defined processes, an external memory storage process, a manual destination input process, and a toner saving process, which are the processes that MFP 1 has become possible to execute after modification of the functions, are newly added as defined processes in the updated user definition data. Further, because “not permitted” is set in the “permission/non-permission” field for the undefined process with the “data storage” attribute in the user definition data of user A shown in FIG. 14A, execution of the external memory storage process newly added as the defined process is not permitted. Furthermore, because “permitted” is set in the “permission/non-permission” field for each of the undefined process with the “security” attribute and the undefined process with the “others” attribute, execution of both the manual destination input process and the toner saving process, newly added as the defined processes, is permitted.

Referring to FIG. 20B, compared to the user definition data of user B shown in FIG. 14B where the facsimile, printing, and scanning processes are defined as the defined processes, the external memory storage, manual destination input, and toner saving processes, which can newly be executed by MFP 1 after modification of the functions, are newly added as the defined processes in the updated user definition data. Further, because “permitted” is set in the “permission/non-permission” field for each of the undefined process with the “data storage” attribute and that with the “others” attribute in the user definition data of user B shown in FIG. 14B, execution of both the external memory storage process and the toner saving process newly added as the defined processes is permitted. Furthermore, because “not permitted” is set in the “permission/non-permission” field for the undefined process with the “security” attribute, execution of the manual destination input process newly added as the defined process is not permitted.

According to the second embodiment, when the processes that can be executed by MFP 1 are modified, MFP 1 updates the user definition data by determining whether a respective user is permitted to execute the process that MFP 1 can now execute and that is not set as the defined process in the current user definition data. Accordingly, the user definition data stored before modification of the functions is updated to the user definition data in which permission or non-permission to execute a respective process added as a result of modification of the functions is defined for a respective user.

### Third Embodiment

In the second embodiment, the user definition data is updated in MFP 1. In the image processing system according to a third embodiment, while the user definition data is stored in each of MFPs 1 to 4, server 200 is responsible for updating the user definition data. To this end, server 200 acquires the user definition data from a first MFP in which the user definition data to be updated is stored, and acquires process information regarding the processes that can be executed by a second MFP as well as apparatus-based information from the second MFP in which updated user definition data is to be stored, to update the user definition data. Server 200 then transmits the updated user definition data to the second MFP for storage. The first MFP and the second MFP may be the same or different from each other. Here, it is assumed that an MFP 5 is newly connected to network 30, and the user definition data stored in MFP 1 is updated and stored in MFP 5.

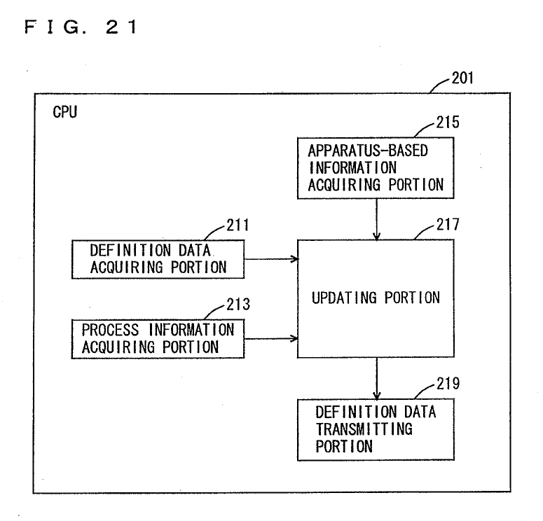

FIG. 21 is a functional block diagram schematically showing the functions of the CPU included in the server according to the third embodiment. Referring to FIG. 21, CPU 201 included in server 200 of the third embodiment includes: a definition data acquiring portion 211 to acquire user definition data; an apparatus-based information acquiring portion 215 to acquire apparatus-based information; a process information acquiring portion 213 to acquire process information regarding the processes that can be executed by the MFP; an updating portion 217 to update the user definition data; and a definition data transmitting portion 219 to transmit the updated user definition data.

Definition data acquiring portion 211 acquires from MFP 1 the user definition data stored therein. When the user inputs an operation to designate MFP 1 to operation portion 207, definition data acquiring portion 211 determines to acquire the user definition data from MFP 1. Definition data acquiring portion 211 outputs the user definition data acquired from MFP 1 to updating portion 217.

Apparatus-based information acquiring portion 215 acquires from MFP 5 the apparatus-based information stored therein. Apparatus-based information acquiring portion 215 acquires the apparatus-based information from MFP 5 in which the updated user definition data is to be stored. When the user inputs an operation to designate MFP 5 to operation portion 207, apparatus-based information acquiring portion 215 determines to acquire the apparatus-based information from MFP 5. Apparatus-based information acquiring portion 215 outputs the apparatus-based information acquired from MFP 5 to updating portion 217.

Process information acquiring portion 213 acquires the process information from MFP 5. The process information includes process identification information for identification of the respective processes that MFP 5 can execute. When the user inputs an operation to designate MFP 5 to operation portion 207, process information acquiring portion 213 determines to acquire the process information from MFP 5. Process information acquiring portion 213 outputs the process information acquired from MFP 5 to updating portion 217.

Updating portion 217 sets any process among the processes identified by the process identification information included in the process information that is not set as a defined process in the user definition data, to a defined process. At this time, in the case where the apparatus-based information is set to permit execution of an undefined process and “permitted” is set in the “undefined process permission/non-permission” field in the user definition data, updating portion 217 sets “permitted” in the “permission/non-permission” field associated with the process identification information of the process newly set as the defined process. On the other hand, in the case where the apparatus-based information is set not to permit execution of the undefined process, or in the case where the apparatus-based information is set to permit execution of the undefined process but “not permitted” is set in the “undefined process permission/non-permission” field in the user definition data, then updating portion 217 sets “not permitted” in the “permission/non-permission” field associated with the process identification information of the process newly set as the defined process. Updating portion 217 outputs the updated user definition data to definition data transmitting portion 219.

Definition data transmitting portion 219 transmits the updated user definition data input from updating portion 217 to MFP 5 from which process information acquiring portion 213 acquired the process information, for storage. As a result, the updated user definition data is stored in the HDD in MFP 5. The user definition data is automatically stored in the newly added MFP 5, which eliminates the need of the process of registering the user definition data in MFP 5.

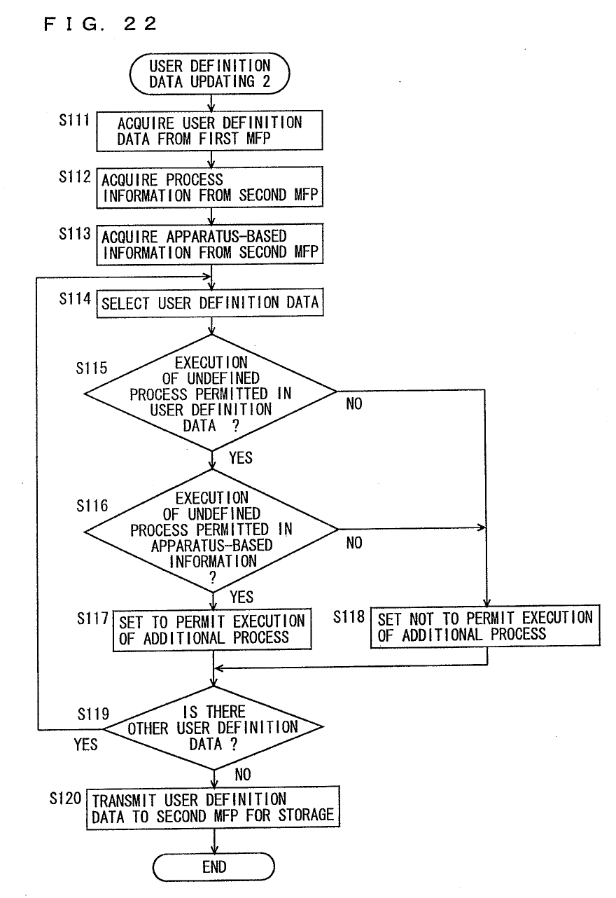

FIG. 22 is a second flowchart illustrating an example of the flow of the user definition data updating processing. The user definition data updating processing shown in FIG. 22 is carried out by CPU 201 of server 200 as CPU 201 executes a user data updating program. Referring to FIG. 22, CPU 201 acquires user definition data from a first MFP, which is MFP 1 in this example (step S111). It then acquires process information from a second MFP, which is MFP 5 in this example (step S112). It further acquires apparatus-based information from the second MFP (MFP 5) (step S113).

The processing in steps S114 to S119 are identical to the processing in steps S24 and S26 to S30 shown in FIG. 17, and thus, description thereof will not be repeated here. In step S120, the updated user definition data is transmitted to the second MFP (MFP 5) for storage, whereby the process is terminated.

According to the third embodiment, server 200 acquires, from MFP 1 corresponding to the first MFP, the user definition data in which a defined process for which permission or non-permission to execute the process is predetermined and permission or non-permission to execute an undefined process other than the defined process is also defined for a respective user, and acquires, from MFP 5 corresponding to the second MFP, the process information regarding a plurality of processes that MFP 5 can execute, to determine whether a respective user is permitted to execute a process that is among the plurality of processes included in the acquired process information and that is not set as the defined process in the acquired user definition data, to thereby update the acquired user definition data. Server 200 then transmits the updated user definition data to MFP 5 as the second MFP for storage. Accordingly, it is possible to use the user definition data acquired from MFP 1 that is the first MFP to generate the user definition data in which permission or non-permission to execute a respective one of the plurality of processes that MFP 5 as the second MFP can execute is defined for a respective user.

Further, server 200 acquires, from MFP 5 corresponding to the second MFP, the apparatus-based information in which permission or non-permission to execute an undefined process is set on an apparatus basis, and in the case where execution of the undefined process is permitted in the user definition data acquired from MFP 1, server 200 sets such that execution of the process that is not set as the defined process in the user definition data is permitted, further on the condition that execution of the undefined process is permitted in the acquired apparatus-based information. Accordingly, it is possible to set to disallow execution of an undefined process in preference to the setting in the second MFP.

While the image processing system has been described in the above embodiments, the present invention may of course be understood as an authentication method or a definition data updating method for performing the processing shown in FIGS. 8, 9, 17, 18, and 22, or as an authentication program or a definition data updating program for causing a computer to execute the authentication method or the definition data updating method.

The foregoing and other objects, features, aspects and advantages of the present invention will become more apparent from the following detailed description of the present invention when taken in conjunction with the accompanying drawings.

What is claimed is:

1. An image processing apparatus comprising:
a process execution portion capable of executing a plurality of processes;
a user authentication portion to perform authentication of a user;
a definition data acquiring portion to acquire user definition data for the user authenticated by said user authentication portion, the user definition data defining a defined process for which permission or non-permission to execute the process is predetermined and also defining permission or non-permission to execute an undefined process other than said defined process; and
a determination portion to determine, for each of said plurality of processes that said process execution portion is capable of executing, that the user is permitted to execute the process in the case where the process is set as said defined process and execution of the process is permitted in said user definition data or in the case where the process is not set as said defined process but execution of said undefined process is permitted in said user definition data.

2. The image processing apparatus according to claim 1, further comprising an apparatus-based setting portion to set permission or non-permission to execute said undefined process on an apparatus basis, wherein
said determination portion determines that the user is permitted to execute said undefined process further on the condition that execution of said undefined process is permitted by said apparatus-based setting portion.

3. The image processing apparatus according to claim 1, wherein
each of said plurality of processes is classified into one of a plurality of attributes, and
said user definition data defines permission or non-permission to execute the processes in accordance with said plurality of attributes.

4. A data processing apparatus comprising:
a communication portion capable of communicating with first and second image processing apparatuses;
a definition data acquiring portion to acquire user definition data from said first image processing apparatus, the user definition data defining, for a respective user, a defined process for which permission or non-permission to execute the process is predetermined and permission or non-permission to execute an undefined process other than said defined process;
a process information acquiring portion to acquire, from said second image processing apparatus, process information regarding a plurality of processes that said second image processing apparatus is capable of executing;
an updating portion to update said acquired user definition data by determining whether the respective user is permitted to execute a process that is among said plurality of processes included in said acquired process information and that is not set as said defined process in said acquired user definition data; and
a transmitting portion to transmit said updated user definition data to said second image processing apparatus.

5. The data processing apparatus according to claim 4, wherein in the case where execution of said undefined process is permitted in said acquired user definition data, said updating portion sets such that the corresponding user is permitted to execute the process that is among said plurality of processes included in said acquired process information and that is not set as said defined process in said acquired user definition data, while in the case where execution of said undefined process is not permitted in said acquired user definition data, said updating portion sets such that the corresponding user is not permitted to execute the process that is among said plurality of processes included in said acquired process information and that is not set as said defined process in said acquired user definition data.

6. The data processing apparatus according to claim 5, further comprising an apparatus-based information acquiring portion to acquire apparatus-based information from said second image processing apparatus, the apparatus-based information setting permission or non-permission to execute said undefined process on an apparatus basis, wherein
in the case where execution of said undefined process is permitted in said acquired user definition data, said updating portion sets such that the corresponding user is permitted to execute the process that is not set as said defined process in said acquired user definition data further on the condition that execution of said undefined process is permitted in said acquired apparatus-based information.

7. An image processing apparatus comprising:
a definition data acquiring portion to acquire user definition data which defines, for a respective user, a defined process for which permission or non-permission to execute the process is predetermined and permission or non-permission to execute an undefined process other than said defined process;
a process execution portion capable of executing a plurality of processes; and
an updating portion to update said acquired user definition data when a process that said process execution portion is capable of executing is added, by determining whether the respective user is permitted to execute the added process based on the permission or non-permission to execute said undefined process defined in said user definition data.

8. An authentication method carried out by an image processing apparatus including a process execution portion capable of executing a plurality of processes, the method comprising the steps of:
authenticating a user;
acquiring user definition data for said authenticated user, the user definition data defining a defined process for which permission or non-permission to execute the process is predetermined and also defining permission or non-permission to execute an undefined process other than said defined process; and
for each of said plurality of processes that said process execution portion is capable of executing, determining that the user is permitted to execute the process in the case where the process is set as said defined process and execution of the process is permitted in said user definition data or in the case where the process is not set as said defined process but execution of said undefined process is permitted in said user definition data.

9. The authentication method according to claim 8, further comprising the step of setting permission or non-permission to execute said undefined process on an apparatus basis, wherein
said determining step includes the step of determining that the user is permitted to execute said undefined process further on the condition that execution of said undefined process is set to be permitted in said step of setting on an apparatus basis.

10. The authentication method according to claim 8, wherein
said plurality of processes are grouped into a plurality of attributes, and
said user definition data defines permission or non-permission to execute the processes in accordance with said plurality of attributes.

11. A definition data updating method comprising the steps of:
acquiring user definition data from a first image processing apparatus, the user definition data defining, for a respective user, a defined process for which permission or non-permission to execute the process is predetermined and permission or non-permission to execute an undefined process other than said defined process;
acquiring, from a second image processing apparatus, process information regarding a plurality of processes that said second image processing apparatus is capable of executing;
updating said acquired user definition data by determining whether the respective user is permitted to execute a process that is among said plurality of processes included in said acquired process information and that is not set as said defined process in said acquired user definition data; and
transmitting said updated user definition data to said second image processing apparatus.

12. The definition data updating method according to claim 11, wherein said updating step includes the steps of:
in the case where execution of said undefined process is permitted in said acquired user definition data, setting such that the corresponding user is permitted to execute the process that is among said plurality of processes included in said acquired process information and that is not set as said defined process in said acquired user definition data, and
in the case where execution of said undefined process is not permitted in said acquired user definition data, setting such that the corresponding user is not permitted to execute the process that is among said plurality of processes included in said acquired process information and that is not set as said defined process in said acquired user definition data.

13. The definition data updating method according to claim 12, further comprising the step of acquiring apparatus-based information from said second image processing apparatus, the apparatus-based information setting permission or non-permission to execute said undefined process on an apparatus basis, wherein
said updating step includes the step of, in the case where execution of said undefined process is permitted in said acquired user definition data, setting such that the corresponding user is permitted to execute the process that is not set as said defined process in said acquired user definition data, further on the condition that execution of said undefined process is permitted in said acquired apparatus-based information.

14. An authentication program embodied on a computer readable medium, being executed by a computer that controls an image processing apparatus including a process execution portion capable of executing a plurality of processes, the program causing said computer to perform the steps of:
authenticating a user;
acquiring user definition data for said authenticated user, the user definition data defining a defined process for which permission or non-permission to execute the process is predetermined and also defining permission or non-permission to execute an undefined process other than said defined process; and
for each of said plurality of processes that said process execution portion is capable of executing, determining that the user is permitted to execute the process in the case where the process is set as said defined process and execution of the process is permitted in said user definition data or in the case where the process is not set as said defined process but execution of said undefined process is permitted in said user definition data.

15. A definition data updating program embodied on a computer readable medium, the program causing a computer to perform the steps of:
acquiring user definition data from a first image processing apparatus, the user definition data defining, for a respective user, a defined process for which permission or non-permission to execute the process is predetermined and permission or non-permission to execute an undefined process other than said defined process;
acquiring, from a second image processing apparatus, process information regarding a plurality of processes that said second image processing apparatus is capable of executing;
updating said acquired user definition data by determining whether the respective user is permitted to execute a process that is among said plurality of processes included in said acquired process information and that is not set as said defined process in said acquired user definition data; and
transmitting said updated user definition data to said second image processing apparatus.
